(19) United States
(12) Patent Application Publication
(10) Pub. No.: US 2026/0115879 A1
(43) Pub. Date: Apr. 30, 2026

(54) Tool holding apparatus for a power tool, power tool

(71) Applicant: Hilti Aktiengesellschaft, Schaan (LI)

(72) Inventors: Julian HARBAUM, Peißenberg (DE); Ulrich MANDEL, Buchloe Honsolgen (DE); Karin GROTH, Herrsching (DE)

(21) Appl. No.: 19/353,340

(22) Filed: Oct. 8, 2025

(30) Foreign Application Priority Data
Oct. 24, 2024 (EP) 24208619.7

(51) Int. Cl. B25D 17/24

(52) U.S. Cl. CPC B25D 17/24; B25D 2217/0073; B25D 2250/121; B25D 2250/331

(57) ABSTRACT

A striking mechanism (15) having an idle-strike damping element and a rebound-strike damping element (6, 7), which interact with a tool holder (3), wherein the tool holder (3) is mounted via at least two plain bearings (13a, 13b) to a guide housing (5), and wherein the idle-strike damping element and the rebound-strike damping element (6, 7) are arranged at an axial distance relative to one another on the outer circumferential side of the tool holder (3). It is provided that the idle-strike damping element (6) and/or the rebound-strike damping element (7) is coupled to the tool holder (3) via a front-side or inner circumferential toothing (8) and the same damping element (6 or 7) is coupled to the guide housing (5) via a front-side or outer circumferential toothing (11). A power tool (2), in particular a drill or chisel hammer, having a striking mechanism (15).

This claims priority to European Patent Application EP 24208619.7, filed on Oct. 24, 2024 which is hereby incorporated by reference herein.

The invention relates to a striking mechanism for a power tool. The power tool can in particular be a drill or chisel hammer. Furthermore, the invention relates to a power tool, in particular a drill or chisel hammer, having a tool holding apparatus according to the invention.

### BACKGROUND

Drills and/or chisel hammers have a striking mechanism that usually transfers the necessary striking energy to a tool via a striking ram. For this purpose, the striking ram is accommodated in an axially movable manner in a tubular tool holder body of a tool holder, into which the tool can be inserted at the other end. The striking ram moves back and forth within the tool holder body between two stops, so that part of the kinetic energy is also transferred to the tool holder body. This can lead to unwanted noise generation and/or unpleasant vibrations of a housing into which the tool holder body is inserted.

From EP 4 400 265 A1, a striking mechanism for a power tool is known which has a tubular tool holder for a tool. The tool holder is accommodated in a guide housing, wherein a coaxially rearwardly arranged striking ram is provided at the proximal end. An arrangement consisting of an idle-strike damping element and a rebound-strike damping element is positioned between the tool holder and the guide housing, which idle-strike damping element and rebound-strike damping element interact with the tool holder in order to realize idle-strike and rebound-strike damping. The tool holder is mounted on the guide housing via at least two plain bearings provided on axial outer sides of the arrangement consisting of an idle-strike damping element and a rebound-strike damping element. The idle-strike damping element and the rebound-strike damping element are arranged at an axial distance relative to one another on the outer circumferential side of the tool holder.

### SUMMARY OF THE INVENTION

It is an object of the present invention to provide damping by means of a modified mounting of a tool holder within a housing or housing part.

The present invention provides a striking mechanism for a power tool, in particular for a drill or chisel hammer, comprising a tubular tool holder for a tool, which is accommodated in a guide housing and at the proximal end of which a coaxially rearwardly arranged striking ram is provided, wherein an arrangement comprising an idle-strike damping element and a rebound-strike damping element is positioned between the tool holder and the guide housing, which interact with the tool holder in order to realize idle strike and rebound strike damping, wherein the tool holder is mounted to the guide housing via at least two plain bearings, which are provided on axial outer sides of the arrangement comprising an idle-strike damping element and a rebound-strike damping element, and wherein the idle-strike damping element and the rebound-strike damping element are arranged at an axial distance relative to one another on the outer circumferential side of the tool holder.

According to the invention, the idle-strike damping element and/or the rebound-strike damping element is coupled to the tool holder via a front-side or inner circumferential toothing and the same damping element is coupled to the guide housing via a front-side or outer circumferential toothing.

By means of the front-side toothing, a form fit acting in the circumferential direction is established between the idle-strike damping element and/or the rebound-strike damping element and the tool holder, thereby achieving a rotation lock of the idle-strike damping element and/or the rebound-strike damping element with respect to the tool holder. Thus, additional elements for realizing a rotation lock can be omitted. Furthermore, connecting elements, such as screws or pins, for connecting the idle-strike damping element and/or the rebound-strike damping element to the tool holder can be dispensed with. As a result, the number of parts can be reduced. Furthermore, weight can be saved. It can be provided that only the idle-strike damping element or only the rebound-strike damping element—hereinafter also referred to as damping elements—is coupled to the tool holder in this way. Alternatively, it can also be provided that both the idle-strike damping element and the rebound-strike damping element are coupled to the tool holder.

Due to the arrangement of the front-side toothing in each case, the damping elements are at the same time supported in the axial direction. The damping elements can thus achieve damping in both the axial and circumferential directions.

As a result of the idle-strike damping element and/or the rebound-strike damping element having an outer circumferential toothing for coupling with the guide housing, the tool holder is elastically mounted in the guide housing both in the axial direction and in the circumferential direction via the idle-strike damping element and/or the rebound-strike damping element. At the same time, the idle-strike damping element and/or the rebound-strike damping element provide a rotation lock that counteracts any rotation of the tool holder with respect to the guide housing.

Preferably, the tool holder has a ring collar with a toothing, preferably a toothing on both sides, for interaction with the idle-strike damping element and/or the rebound-strike damping element. A toothing on both sides of the ring collar is preferably adapted to the toothing of the idle-strike damping element and/or the rebound-strike damping element, so that they engage with one another when the two damping elements are arranged accordingly in relation to the ring collar.

The two damping elements are preferably arranged on both sides of the ring collar, so that their front-side toothing in each case is in engagement with one of the toothings formed on both sides of the ring collar. Thus, the axial distance between the two damping elements relative to one another corresponds to the width of the ring collar less the toothing formed on both sides. The two damping elements are at the same time supported in the axial direction via the ring collar, namely the idle-strike damping element in a first axial direction and the rebound-strike damping element in a second axial direction, which is opposite to the first axial direction.

In order to be able to bring the front-side toothings of the damping elements into engagement with the toothings of the ring collar of the tool holder, the two damping elements are preferably oriented relative to one another so that the front-side toothings face one another.

Advantageously, the two damping elements are of identical design, so that the same parts can be used, which only have to be arranged in different orientations on the tool holder or the tool holder body. The use of identical parts reduces production costs. The correct orientation of the damping elements during assembly is ensured by the front-side toothing of the damping elements. This is because they only permit one orientation to bring the front-side toothings into engagement with the toothings on both sides of the ring collar of the tool holder.

Furthermore, a power tool, in particular a drill or chisel hammer, having a guide housing and a striking mechanism according to the invention is provided. The tool holder is mounted in a damping manner in two mutually opposite axial directions within the guide housing via the idle-strike damping element and the rebound-strike damping element. Due to the striking mechanism according to the invention, improved damping is achieved, which is noticeable during operation of the power tool through reduced noise generation along with reduced vibrations. Furthermore, the striking mechanism according to the invention achieves a weight saving, since the number of parts is reduced by functional integration into the idle-strike damping element and/or the rebound-strike damping element. Weight savings are also achieved by the fact that the assembly of the two damping elements preferably does not require any metallic connecting elements, such as screws or pins.

Preferably, the idle-strike damping element and/or the rebound-strike damping element is/are coupled to the housing part via an outer circumferential toothing. The outer circumferential toothing produces a form fit acting in the circumferential direction, so that the tool holder is elastically mounted in the circumferential direction and is also secured against rotation with respect to the guide housing.

Furthermore, the guide housing preferably has an inner circumferential toothing for coupling with the idle-strike damping element and/or the rebound-strike damping element. The inner circumferential toothing of the guide housing is preferably adapted to the outer circumferential toothing of the idle-strike damping element and/or the rebound-strike damping element, so that they engage with one another after the tool holder has been inserted into the guide housing.

In a further development of the invention, it is provided that the idle-strike damping element and the rebound-strike damping element are arranged for axial position securing between two annular plain bearings that are preloaded directly or indirectly via sealing rings in the radial direction against the tool holder and the guide housing. The annular plain bearings can be mounted on the tool holder together with the damping elements and then inserted into the guide housing together with the tool holder. The radial preload of the plain bearings serves to secure the axial position, so that axial displacement of the plain bearings along with the damping elements is prevented during insertion. The plain bearings thus make it easier to assemble the power tool. At the same time, sealing is achieved via the radial preload, which can be optimized by preloading the plain bearings in the radial direction not directly but indirectly via sealing rings. Advantageously, sealing rings are arranged on both sides of the plain bearings in order to seal both the radial gap between the tool holder and the plain bearing and the radial gap between the plain bearing and the guide housing.

According to a preferred embodiment of the invention, the striking mechanism is arranged in the guide housing, wherein the striking mechanism is designed with a striking piston for acting on a striking ram, wherein the striking ram is mounted in an axially movable manner in the tool holder. A striking force acting in the axial direction can be exerted on the striking ram via the striking piston of the striking mechanism and, via the striking ram, on a tool accommodated in the tool holder, so that the tool is moved back and forth in the axial direction. The tool could be a chisel, for example. The striking piston, the striking ram and the tool are arranged coaxially for this purpose.

### BRIEF DESCRIPTION OF THE DRAWINGS

A preferred embodiment of the invention is described in more detail below with reference to the accompanying drawings. In the drawings:

FIG. 1 shows a section of a longitudinal section through a power tool with a striking mechanism according to the invention,

FIG. 2 is a perspective view of the power tool of FIG. 1,

FIG. 3 is a perspective view of the tool holder and damping elements of the tool holder of the power tool of FIG. 1 (prior to assembly); and

FIG. 4 is a perspective view of the guide housing of the power tool of FIG. 1.

### DETAILED DESCRIPTION

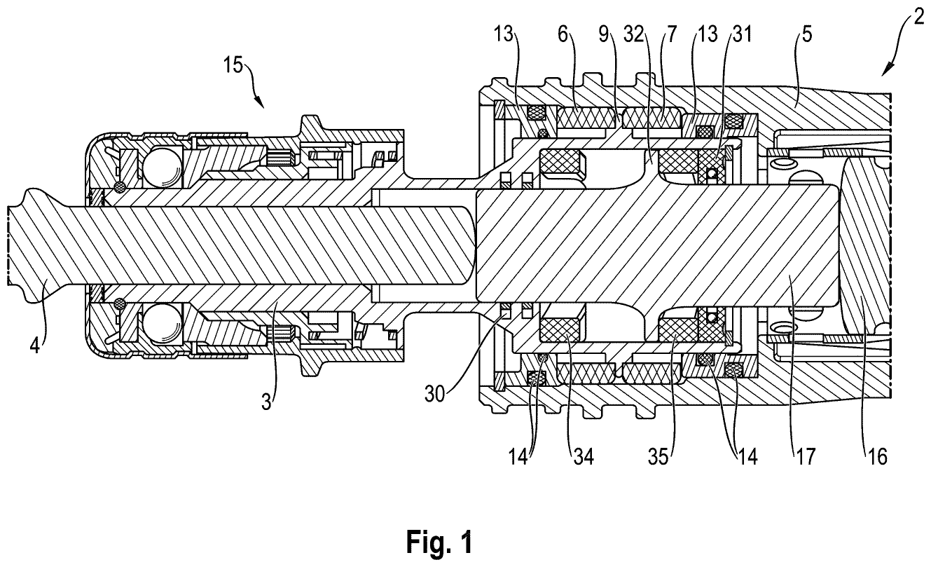

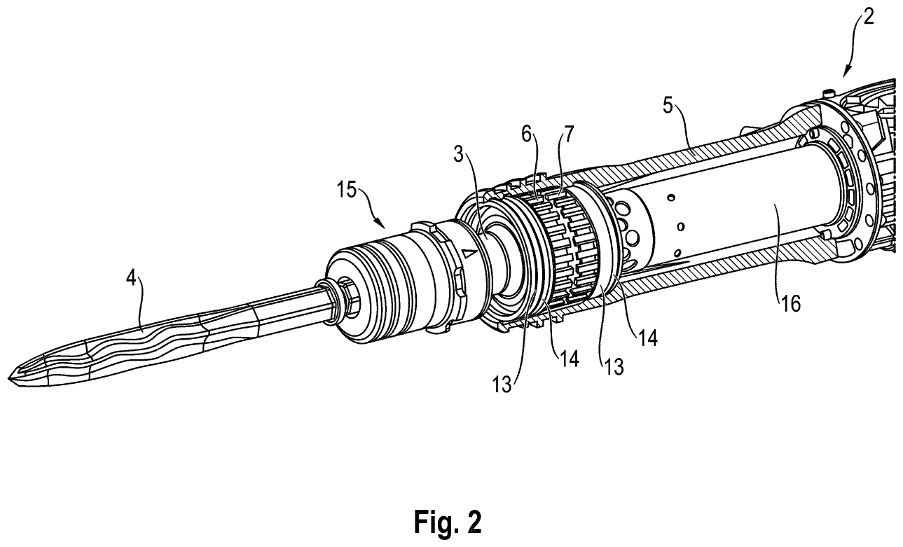

FIGS. 1 and 2 show a power tool 2 with a striking mechanism 15 according to the invention. The striking mechanism is accommodated in a tubular guide housing 5. The striking mechanism 15 comprises a striking piston 16 for acting on a striking ram 17, which is accommodated in an axially movable manner in a tubular tool holder 3 or tool holder body.

The fastening of the tool 4 within the tool holder 3 can be carried out in a conventional manner, so that a more detailed description is dispensed with. Instead, the focus is on the mounting of the tool holder 3 within the guide housing 5.

In the region of a distal end of the tool holder 3, a tool 4 can be inserted, which is held in an axially displaceable manner in the tool holder 3. At a proximal end, a striking ram 17 or striker is arranged in the tool holder 3. The striking ram 17 is arranged so as to be axially displaceable in order to transmit a striking pulse applied to the striking ram 17 to the tool 4.

The striking ram 17 is guided via a distal and a proximal striking ram bearing 30, 31. In a central region, the striking ram 17 has a radial expansion 32 that, in the event of an idle strike, interacts with a striking ram idle-strike damping element 34 on the side of the distal striking ram bearing 30, so that the striking energy of the striking ram 17 is dampened. A striking ram rebound-strike damping element 35 is arranged on the side of the proximal striking ram bearing 31, with which striking ram rebound-strike damping element the striking energy of the striking ram 17 is absorbed in the event of a rebound strike. This prevents the striking energy from being transmitted undamped to the structure.

The tool holder 3 forms a ring collar 9 or radial extension. An annular idle-strike damping element 6 is arranged between the guide housing 5 and the tool holder 3 on the distal side with respect to the ring collar 9. In the case of an idle strike, in which the tool holder 4 is displaced in the direction of the idle-strike damping element 6, the radial extension 3 interacts with the idle-strike damping element 6, so that an idle strike is dampened. An annular rebound-strike damping element 7 is arranged on a proximal side of the ring collar 9. In the event of a rebound strike, the ring collar 9 is displaced in the direction of the rebound-strike damping element 7, so that the rebound strike is dampened.

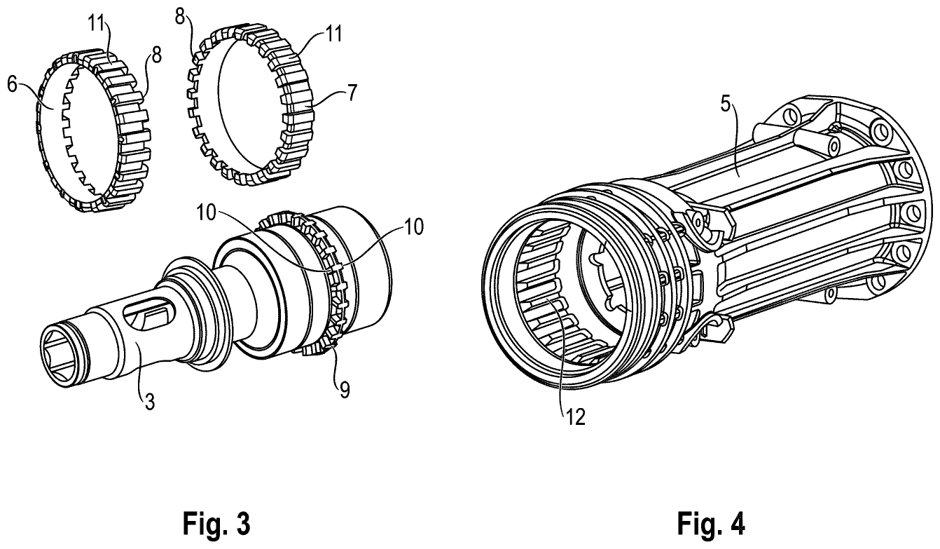

As can be seen in particular in FIG. 3, both the idle-strike damping element 6 and the rebound-strike damping element 7 in each case have a front-side toothing 8 and an outer circumferential toothing 11. The two damping elements 6, 7 are oriented relative to one another so that the front-side toothings 8 face one another. The ring collar 9 of the tool holder 3 extends between the two damping elements 6, 7 and has toothings 10 on both sides. The front-side toothings 8 of the two damping elements 6, 7 engage into these. The outer circumferential toothings 11 of the two damping elements 6, 7 are in engagement with toothings 12 that are formed on the inner circumferential side of the guide housing 5 (see FIG. 4).

The assembly of the power tool 2 can be undertaken as follows:

First, the two damping elements 6, 7 are pushed onto the tool holder 3, wherein the idle-strike damping element 6 is placed on one side and the rebound-strike damping element 7 is placed on the other side. In the final position, the front-side toothings 8 of the damping elements 6, 7 engage with the toothings 10 formed on both sides of the ring collar 9. For securing the position of the damping elements 6, 7 on the tool holder 3, annular plain bearings 13 are subsequently placed on the tool holder 3 and pushed up to the damping elements 6, 7 (see FIG. 1). The plain bearings 13 have inner circumferential and outer circumferential sealing rings 14, wherein the inner circumferential sealing rings 14 rest against the tool holder 3 under a radial preload after the plain bearings 13 have been assembled on the tool holder 3. Subsequently, the pre-mounted unit can be inserted into the guide housing 5, wherein the outer circumferential sealing rings 14 of the plain bearings 13 are preloaded radially against the guide housing 5.

The tool holder 3 is elastically mounted in the guide housing 5 via the two damping elements 6, 7, both in the axial direction and in the circumferential direction. Accordingly, via the two damping elements 6, 7, improved damping during operation of the power tool 2 is achieved.

### LIST OF REFERENCE SIGNS

2 Power tool
3 Tool holder
4 Tool
5 Guide housing
6 Idle-strike damping element
7 Rebound-strike damping element
8 Toothing
9 Ring collar
10 Toothing
11 Toothing
12 Toothing
13 Plain bearing
14 Sealing ring
15 Striking mechanism
16 Striking piston
17 Striking ram
30 Distal striking ram bearing
31 Proximal striking ram bearing
32 Radial expansion
34 Striking ram idle-strike damping element
35 Striking ram rebound-strike damping element

What is claimed is:

1. A striking mechanism for a power tool comprising:
a tubular tool holder for a tool, the tubular tool holder being is accommodated in a guide housing, a coaxially rearwardly arranged striking ram being provided at the proximal end of the tubular tool holder; and
an arrangement including an idle-strike damper and a rebound-strike damper being positioned between the tool holder and the guide housing, the idle-strike damper and the rebound-strike damper interacting with the tool holder in order to realize idle strike and rebound strike damping;
the tool holder being mounted to the guide housing via at least two plain bearings provided on axial outer sides of the arrangement and wherein the idle-strike damper and the rebound-strike damper are arranged at an axial distance relative to one another on an outer circumferential side of the tool holder;
the idle-strike damper or the rebound-strike damper being coupled to the tool holder via a front-side or an inner circumferential toothing and the coupled idle-strike or rebound-strike damper coupled to the guide housing via the front-side or outer circumferential toothing.

2. The striking mechanism as recited in claim 1 wherein the tool holder has a ring collar with toothing for interaction with the idle-strike damper or the rebound-strike damper.

3. The striking mechanism as recited in claim 1 wherein the toothing is on both sides of the ring collar.

4. The striking mechanism as recited in claim 1 wherein the idle-strike damper and the rebound-strike damper each have the front-side toothings facing one another.

5. The striking mechanism as recited in claim 1 wherein the idle-strike damper and the rebound-strike damping element are of identical design.

6. A power tool comprising:
a guide housing and the striking mechanism as recited in claim 1, the tool holder being mounted in a damping manner in two mutually opposite axial directions within the guide housing via the idle-strike damper and the rebound-strike damper.

7. The power tool as recited in claim 6 wherein the idle-strike damper or the rebound-strike damper is coupled to the guide housing via the outer circumferential toothing.

8. The power tool as recited in claim 6 wherein the guide housing has an inner circumferential toothing for coupling with the idle-strike damper or the rebound-strike damper.

9. The power tool as recited in claim 6 wherein the idle-strike damper and the rebound-strike damper are arranged for axial position securing between two annular plain bearings preloaded directly or indirectly via sealing rings in a radial direction against the tool holder and the guide housing.

10. The power tool as recited in claim 6 wherein the striking mechanism is arranged in the guide housing, wherein the striking mechanism is designed with a striking piston for interaction with the striking ram.

11. The power tool as recited in claim 6 wherein the power tool is a drill or chisel hammer.
